(19) United States
(12) Patent Application Publication
(10) Pub. No.: US 2016/0237879 A1
(43) Pub. Date: Aug. 18, 2016

(54) Fuel Combustion System Having Component with Thermal Conductor Member and Method of Making Same

(71) Applicant: Caterpillar Inc., Peoria, IL (US)

(72) Inventor: Matthew I. Rowan, Chillicothe, IL (US)

(73) Assignee: CATERPILLAR INC., Peoria, IL (US)

(21) Appl. No.: 14/623,216

(22) Filed: Feb. 16, 2015

(51) Int. Cl. F02B 19/10; F02M 31/14; F01P 3/02; F02B 19/16

(52) U.S. Cl. CPC F02B 19/1009; F02B 19/16; F02B 19/1014; F02M 31/145; F01P 3/02; F01P 2003/024; B33Y 10/00

(57) ABSTRACT

A component of a fuel combustion system of an engine includes a body and a thermal conductor member. The body includes a fuel surface configured to be in heat-transferring relationship with a fuel source within the fuel combustion system. The body is made from a first material having a first thermal conductivity value. The thermal conductor member is disposed within the body and is made from a second material, which is different from the first material and has a second thermal conductivity value that is higher than the first thermal conductivity value. The thermal conductor member includes a first end disposed adjacent the fuel surface and a second end in distal relationship thereto. The thermal conductor member extends between the first and second ends along a thermal conduction path defined within the body and extending away from the fuel surface.

### TECHNICAL FIELD

This patent disclosure relates generally to a fuel combustion system for an internal combustion engine and, more particularly, to a component of a fuel combustion system for an internal combustion engine.

### BACKGROUND

One type of internal combustion engines typically employ a number of cylinders which compress a fuel and air mixture such that upon firing of a spark plug associated with each cylinder, the compressed mixture ignites. The expanding combustion gases resulting therefrom move a piston within the cylinder. Upon reaching an end of its travel in one direction within the cylinder, the piston reverses direction to compress another volume of the fuel and air mixture. The resulting mechanical kinetic energy can be converted for use in a variety of applications, such as, propelling a vehicle or generating electricity, for example.

Another type of internal combustion engine, known as a compression ignition engine, uses a highly-compressed gas (e.g., air) to ignite a spray of fuel released into a cylinder during a compression stroke. In such an engine, the air is compressed to such a level as to achieve auto-ignition of the fuel upon contact between the air and fuel. The chemical properties of diesel fuel are particularly well suited to such auto-ignition.

The concept of auto-ignition is not limited to diesel engines, however, and has been employed in other types of internal combustion engines as well. For example, a self-igniting reciprocating internal combustion engine can be configured to compress fuel in a main combustion chamber via a reciprocating piston. In order to facilitate starting, each main combustion chamber is associated with a prechamber, particularly useful in starting cold temperature engines. Fuel is injected into not only the main combustion chamber, but also the combustion chamber of the prechamber, as well, such that upon compression by the piston, a fuel and air mixture is compressed in both chambers. A glow plug or other type of heater is disposed within the prechamber to elevate the temperature therein sufficiently to ignite the compressed mixture. The combustion gases resulting from the ignition in the prechamber are then communicated to the main combustion chamber.

Other types of internal combustion engines use natural gas as the fuel source and include at least one piston reciprocating within a respective cylinder. A spark plug is positioned within a cylinder head associated with each cylinder and is fired on a timing circuit such that upon the piston reaching the end of its compression stroke, the spark plug is fired to thereby ignite the compressed mixture.

In still further types of internal combustion engines, prechambers are employed in conjunction with natural gas engines. Given the extremely high temperatures required for auto-ignition with natural gas and air mixtures, glow plugs or other heat sources such as those employed in typical diesel engines, can be ineffective. Rather, a prechamber is associated with each cylinder of the natural gas engine and is provided with a spark plug to initiate combustion within the prechamber which can then be communicated to the main combustion chamber. Such a spark-ignited, natural gas engine prechamber is provided in, for example, the 3600 series natural gas engines commercially available from Caterpillar Inc. of Peoria, Ill.

The components of internal combustion engines can be subjected to very high temperatures. For example, the surfaces defining the orifices of the nozzle of a member of a fuel combustion system, such as a prechamber nozzle, for example, can be subjected to very high temperatures as a result of the flow and temperature characteristics of the fuel mixtures traveling therethrough. In the case of a prechamber assembly, the high temperatures can be caused by the velocity of the fuel/air mixture entering the nozzle through the orifices and the ignition flame front discharged from the nozzle out through the orifices. As a result, the high temperatures to which the orifices are subjected can cause degradation of the nozzle and impair the function of the nozzle over time.

U.S. Pat. No. 4,224,980 is entitled, “Thermally Stressed Heat-Conducting Structural Part or Corresponding Structure Part Cross Section.” The '980 patent is directed to a thermally stressed heat-conducting structural part with a temperature gradient that forms during operation, in which at least one layer of metal hydride is embedded in a hydrogen-impervious and heat-conducting manner transversely to the temperature gradient.

U.S. Patent Application Publication No. 2013/0139784 is entitled, “Prechamber Device for Internal Combustion Engine,” and is directed to a prechamber device for an internal combustion engine, comprising a shell formed of a first material having a first thermal conductivity and a first strength. The shell includes an interior portion including and interior wall, an exterior portion including an exterior wall, at least one open area formed in the exterior wall at a periphery of the prechamber device, a cavity formed between the interior portion and the exterior portion, and a chamber formed by the interior wall. A thermally conductive core portion is positioned within the cavity. The thermally conductive core portion is in physical contact with the interior portion and the exterior portion and is exposed by the at least one open area in the exterior wall. The thermally conductive core portion is formed of a second material having a second thermal conductivity higher than the first thermal conductivity and a second strength lower than the first strength.

There is a continued need in the art to provide additional solutions to enhance the performance of a component of a fuel combustion system. For example, there is a continued need to enable a member of a fuel combustion system to withstand the extreme temperature to which it can be subjected to improve its durability and useful life.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

In an embodiment, the present disclosure describes a fuel combustion component of a fuel combustion system of an engine. The fuel combustion component includes a body and a thermal conductor member.

The body includes a fuel surface which is configured to be in heat-transferring relationship with a source of fuel within the fuel combustion system. The body is made from a first material having a first thermal conductivity value.

The thermal conductor member is disposed within the body. The thermal conductor member is made from a second material having a second thermal conductivity value. The second material is different from the first material, and the second thermal conductivity value is greater than the first thermal conductivity value.

The thermal conductor member includes a first end and a second end. The first end is disposed adjacent the fuel surface of the body. The second end is in distal relationship to the fuel surface relative to the first end. The thermal conductor member extends between the first end and the second end along a thermal conduction path. The thermal conduction path is defined within the body and extends away from the fuel surface.

In yet another embodiment, a fuel combustion system includes a cylinder block, a cylinder head, and a fuel combustion component. The cylinder block defines, at least partially, a main combustion chamber. The cylinder head is removably secured to the cylinder head. At least one of the cylinder block and the cylinder head defines a coolant passage which is adapted to be placed in communication with a source of coolant.

The fuel combustion component is in communication with the main combustion chamber. The fuel combustion component includes a body and a thermal conductor member.

The body is positioned adjacent the coolant passage. The body includes a fuel surface which is in communication with the main combustion chamber. The body is made from a first material having a first thermal conductivity value.

The thermal conductor member is disposed within the body. The thermal conductor member is made from a second material having a second thermal conductivity value. The second material is different from the first material, and the second thermal conductivity value is greater than the first thermal conductivity value.

The thermal conductor member includes a first end and a second end. The thermal conductor member extends between the first end and the second end. The first end is disposed adjacent the fuel surface of the body. The second end is disposed adjacent the coolant passage.

In still another embodiment, a method of making a fuel combustion component of a fuel combustion system of an engine is described. The method of making includes manufacturing a body. The body includes a fuel surface configured to be in heat-transferring relationship with a source of fuel within the fuel combustion system. The body is made from a first material having a first thermal conductivity value.

A thermal conductor member is manufactured. The thermal conductor member includes a first end and a second end. The thermal conductor member extends between the first end and the second end. The thermal conductor member is made from a second material having a second thermal conductivity value. The second material is different from the first material, and the second thermal conductivity value is greater than the first thermal conductivity value.

The thermal conductor member is embedded within the body such that the first end is disposed adjacent the fuel surface of the body. The second end is in distal relationship to the fuel surface relative to the first end. The thermal conductor member extends from the first end to the second end along a thermal conduction path defined within the body and extending away from the fuel surface.

Further and alternative aspects and features of the disclosed principles will be appreciated from the following detailed description and the accompanying drawings. As will be appreciated, the principles related to fuel combustion systems, fuel combustion components, and methods of making a fuel combustion component for a fuel combustion system of an engine disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a diagrammatic, longitudinal cross-sectional view of an embodiment of a fuel combustion system constructed in accordance with principles of the present disclosure and including an embodiment of a fuel combustion component in the form of a prechamber nozzle constructed in accordance with principles of the present disclosure.

FIG. 2 is a diagrammatic, longitudinal cross-sectional view of an embodiment of a fuel combustion component in the form of a prechamber nozzle constructed in accordance with principles of the present disclosure, the nozzle being suitable for use in embodiments of a fuel combustion system following principles of the present disclosure and having a prechamber assembly.

FIG. 3 is an enlarged, detail view of the nozzle of FIG. 2, as indicated by rectangle III in FIG. 2.

FIG. 4 is a diagrammatic, longitudinal cross-sectional view of another embodiment of a fuel combustion component in the form of a fuel injector constructed in accordance with principles of the present disclosure.

FIG. 5 is an enlarged, detail view of the fuel injector of FIG. 4, as indicated by circle V in FIG. 4.

FIG. 6 is a flowchart illustrating steps of an embodiment of a method of making a component of a fuel combustion system of an engine following principles of the present disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION

The present disclosure provides embodiments of a component of a fuel combustion system of an engine. In embodiments, the fuel combustion component, such as a prechamber assembly, a fuel injector, a piston, or an exhaust valve, for example, can be mounted to a cylinder head or cylinder block of an internal combustion engine. Exemplary engines include those used in vehicles, electrical generators, and pumps, for examples.

Embodiments of a fuel combustion component constructed according to principles of the present disclosure can include at least one thermal conductor member embedded within a body thereof that helps facilitate the heat transfer between a flow of a fuel mixture/flame front and a fuel surface of the body with which the flow of the fuel mixture/flame front is in heat-transferring relationship. The thermal conductor member(s) can help reduce the temperature within the body by facilitating heat transfer along a respective thermal conduction path defined within the body.

In embodiments, each thermal conductor member can be configured to extend axially between a first end adjacent the fuel surface and a second end in distal relationship to the fuel surface relative to the first end such that the thermal conductor follows a primary direction of heat flow along its axial length. In embodiments, each thermal conductor member can be configured based upon computer modeling to enhance heat transfer along a temperature gradient within the body away from the fuel surface.

Embodiments of a fuel combustion component constructed according to principles of the present disclosure can be made using additive manufacturing techniques. In embodiments, the thermal conductor members can comprise thermal conductor filaments that occupy a small fraction of the total volume defined by the body of the fuel combustion component.

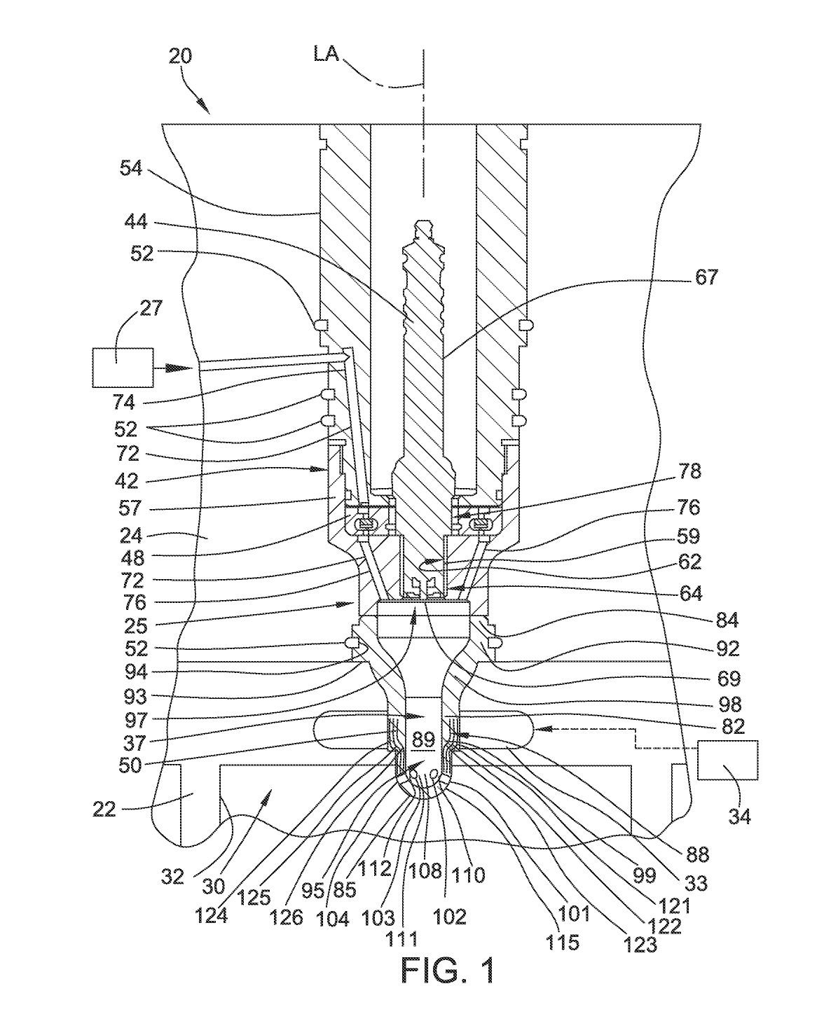

Turning now to the FIGURES, there is shown in FIG. 1 an exemplary embodiment of a fuel combustion system 20 constructed in accordance with principles of the present disclosure. The fuel combustion system 20 can be used in any suitable internal combustion engine, such as an engine configured as part of an electrical generator or a pump, for example. The fuel combustion system 20 can be used with any suitable fuel with an appropriate fuel/air ratio. In embodiments, fuels with different ignition and burning characteristics and different specific fuel to air ratios can be used. The fuel combustion system 20 can include a cylinder block 22, a cylinder head 24, a prechamber assembly 25 having a fuel combustion component in the form of a nozzle 50 constructed in accordance with principles of the present disclosure, a supplemental fuel source 27, and a variety of other combustion devices, as will be appreciated by one skilled in the art.

Referring to FIG. 1, the cylinder block 22 defines, at least partially, a main combustion chamber 30. In embodiments, the cylinder block 22 can define a plurality of cylinders 32 (one of which is shown in FIG. 1) within which is defined the corresponding main combustion chamber 30. In embodiments, a cylinder liner can be disposed within each cylinder 32. The cylinder liner can be removably secured in the cylinder block 22.

The cylinder head 24 can be removably attached to the cylinder block 22 via suitable fasteners, such as a plurality of bolts, as will be appreciated by one skilled in the art. A gasket (not shown) can be interposed between the cylinder block 22 and the cylinder head 24 to seal the interface therebetween. The cylinder head 24 typically has bores machined for engine valves (not shown), e.g., inlet and exhaust valves, and other members of the fuel combustion system 20 (not shown), e.g., fuel injectors, glow plugs, sparks plugs, and combinations thereof, as will be appreciated by one skilled in the art. In other embodiments, the fuel combustion system 20 can include a fuel injector having a nozzle constructed according to principles of the present disclosure.

Each cylinder 32 of the cylinder block 22 can house a reciprocally movable piston (not shown), which is coupled to a crankshaft via a suitable transfer element (e.g., a piston rod or connecting rod). The piston is reciprocally movable within the cylinder 32 for compressing and thereby pressurizing the combustible mixture in the main combustion chamber 30 during a compression phase of the engine. In embodiments, the engine can be configured to have a suitable compression ratio suited for the intended purpose of the engine as will be understood by one skilled in the art.

In embodiments, at least one intake valve mechanism (not shown) and at least one exhaust valve mechanism (not shown) can be operatively positioned within the cylinder head 24 such that the intake valve and the exhaust valve are axially movable in the cylinder head 24. In embodiments, a mechanical valve train (e.g., including a cam, follower, and push rod mechanism) or other hydraulic and/or electric control device can be used in a conventional manner to selectively operate the intake valve mechanism and the exhaust valve mechanism. In particular, the inlet valve mechanism can be opened to admit a predetermined amount of a lean gaseous combustible mixture of fuel and air directly into the main combustion chamber 30 above the piston during an intake phase of the engine. The exhaust valve mechanism can be opened to permit the exhaust of the gases of combustion from the main combustion chamber 30 during an exhaust phase of the engine.

In embodiments, at least one of the cylinder block 22 and the cylinder head 24 defining a coolant passage 33, the coolant passage adapted to be placed in communication with a coolant fluid source 34. The coolant passages 33 can be configured to cool components of the fuel combustion system 20. In embodiments, any suitable cooling system can be placed in fluid communication with the coolant passages 33 to circulate a coolant fluid from the coolant fluid source 34 through the coolant passages 33 in the cylinder block 22 and the cylinder head 24.

The prechamber assembly 25 is removably secured in the cylinder head 24 such that the prechamber assembly 25 is in communication with the main combustion chamber 30. The prechamber assembly 25 defines a precombustion chamber 37, which is in communication with the main combustion chamber 30. The prechamber assembly 25 includes a prechamber housing 42, an ignition device 44 adapted to selectively ignite a fuel disposed in the precombustion chamber 37, a control valve 48, and the nozzle 50. The nozzle 50 and the prechamber housing 42 can be made from any suitable material, such as a suitable, heat-resistant metal. Suitable sealing devices 52, such as o-rings, for example, can be disposed between the prechamber assembly 25 and the cylinder head 24. In other embodiments, other sealing techniques, such as, press fit, metal seals, and the like, can be used.

The nozzle 50 and the prechamber housing 42 cooperate together to define the precombustion chamber 37 and to define a central longitudinal axis LA of the prechamber assembly 25. The nozzle 50 and the prechamber housing 42 include surfaces that are generally surfaces of revolution about the central longitudinal axis LA. The precombustion chamber 37 has a predetermined geometric shape and volume. In embodiments, the volume of the precombustion chamber 37 is smaller than the volume of the main combustion chamber 30. In some embodiments, the volume of the precombustion chamber 37 is in a range between about two and about five percent of the total uncompressed volume of the main combustion chamber 30.

In the illustrated embodiment, the prechamber housing 42 includes an upper member 54 and a lower member 57, which are threadingly secured together. In other embodiments, other types of engagement between the upper member 54 and the lower member 57 can be used, such as, welding, press fitting, and the like. The prechamber housing 42 is hollow and is adapted to receive the ignition device 44 therein.

The ignition device 44 is mounted to the prechamber housing 42. The illustrated lower member 57 of the prechamber housing 42 defines an ignition device bore 59 which has an internal threaded surface 62. The ignition device 44 has an external threaded surface 64 which is threadedly engaged with the internal threaded surface 62 of the ignition device bore 59. The ignition device bore 59 is in communication with the precombustion chamber 37.

In the illustrated embodiment, the ignition device 44 comprises a spark plug 67 with an electrode 69. The spark plug 67 is removably mounted to the prechamber housing 42 such that the electrode 69 is in communication with the precombustion chamber 37 and such that the electrode 69 is substantially aligned with the central longitudinal axis LA. The spark plug 67 is threadedly received in the ignition device bore 59 with the electrode 69 exposed to the precombustion chamber 37 by way of the ignition device bore 59. The spark plug 67 can be adapted to be electrically energized in a conventional manner.

In embodiments, at least one of the prechamber housing 42 and the nozzle 50 define a supplemental fuel passage 72. The supplemental fuel passage 72 is in communication with the precombustion chamber 37 and with the supplemental fuel source 27. In embodiments, the fuel of the supplemental fuel source 27 can have a richer fuel/air ratio than the fuel/air ratio of the fuel supplied directly to the main combustion chamber 30 with which the prechamber assembly 25 is associated.

In the illustrated embodiment of FIG. 1, the upper member 54 and the lower member 57 of the prechamber housing 42 both define the supplemental fuel passage 72. The illustrated upper segment defines a fuel passage entry segment 74. The illustrated lower member 57 of the prechamber housing 42 defines a plurality of precombustion chamber fuel passage segments 76 which are circumferentially arranged about the lower member 57 and in fluid communication with the fuel passage entry segment 74 via a control valve cavity 78 defined between the upper member 54 and the lower member 57.

The control valve 48 is disposed within the prechamber housing 42 and is adapted to selectively occlude the supplemental fuel passage 72 to prevent a flow of fuel from the supplemental fuel source 27 to the precombustion chamber 37. The illustrated control valve 48 is disposed within the control valve cavity 78 and is interposed between the fuel passage entry segment 74 and the precombustion chamber fuel passage segments 76. The control valve 48 can be adapted to selectively permit the flow of fuel from the supplemental fuel source 27 into the precombustion chamber 37 of the prechamber assembly 25 to further promote ignition within the precombustion chamber 37. The control valve 48 can be adapted to open and close with the engine's combustion cycle to prevent contamination of the fuel with exhaust and/or prevent leakage of fuel into the exhaust gases. The control valve 48 can be adapted to prevent the gas product of combustion to flow from the precombustion chamber 37 to the fuel passage entry segment 74 of the supplemental fuel passage 72 during the compression, combustion, and exhaust phases of the engine.

In embodiments, the control valve 48 can be any suitable control valve, such as a check valve assembly including a free-floating ball check having an open mode position permitting the flow of the fuel from the supplemental fuel source 27 to the precombustion chamber 37—and a closed mode position—preventing gas flow from the supplemental fuel source 27 to the precombustion chamber 37. In other embodiments, the control valve 48 can be a shuttle type check valve. In the illustrated embodiment, the control valve 48 is similar in construction and function to the check valve shown and described in U.S. Pat. No. 6,575,192.

The illustrated fuel combustion component in the form of the nozzle 50 is in communication with the main combustion chamber 30. The nozzle 50 includes a nozzle body 82 having a mounting end 84 and a distal tip 85. The nozzle body 82 defines the central longitudinal axis LA which extends between the mounting end 84 and the distal tip 85. The nozzle body 82 is hollow and includes an outer surface 88 and an inner surface 89. The outer surface 88 and the inner surface 89 are both surfaces of revolution about the central longitudinal axis LA.

The mounting end 84 of the nozzle 50 is in abutting relationship with the lower member 57 of the prechamber housing 42. Any suitable technique can be used to provide a seal between the nozzle 50 and the lower member 57 of the prechamber housing 42, such as, o-rings, press fit, metal seals, gaskets, welding, and the like.

The mounting end 84 of the nozzle body 82 includes an annular flange 92 that defines a seat 93 which can be engaged with the cylinder block 22 and/or the cylinder head 24. The mounting end 84 of the nozzle body 82 defines an external circumferential groove 94 configured to receive a suitable sealing device 52 (e.g., an o-ring) therein for sealing.

The nozzle body 82 is positioned adjacent one of the coolant passages 33 such that coolant fluid circulating through the coolant passage is in heat-transferring relationship with the nozzle body 82. The nozzle body 82 projects from the cylinder head 24 such that the distal tip 85 of the nozzle body 82 is disposed in the main combustion chamber 30. Any suitable sealing technique can be used to seal the interface between the nozzle 50 and the cylinder head 24 and/or the cylinder block 22, such as, a gasket, a taper fit, and/or a press fit to isolate fuel, combustion gases, and engine coolant therein.

The inner surface 89 of the nozzle body 82 defines an interior chamber 95 which is open to and in communication with a distal cavity 97 defined in the lower member 57 of the prechamber housing 42. The interior chamber 95 of the nozzle body 82 and the distal cavity 97 of the lower member 57 together define the precombustion chamber 37 of the prechamber assembly 25. The interior chamber 95 of the nozzle body 82 is open to the electrode 69 of the spark plug 67 and is in fluid communication with the supplemental fuel passage 72 via the precombustion chamber fuel passage segments 76 of the lower member 57.

The mounting end 84 of the nozzle body 82 is generally cylindrical. The nozzle body 82 includes a converging portion 98 disposed adjacent the mounting end 84 and a distal cylindrical portion 99 adjacent the distal tip 85. The distal cylindrical portion 99 has a smaller diameter than that of the mounting end 84.

The nozzle body 82 defines a plurality of orifices 101, 102, 103, 104 in the distal tip 85. The orifices 101, 102, 103, 104 are in communication with the interior chamber 95 of the nozzle body 82 and with the main combustion chamber 30 when the prechamber assembly 25 is installed in the cylinder head 24. The illustrated orifices 101, 102, 103, 104 are substantially identical to each other. Accordingly, it will be understood that the description of one orifice is applicable to the other orifices, as well.

In embodiments, the nozzle body 82 can define any suitable number of orifices to achieve the desired swirl/mixing characteristics within the interior chamber 95 of the nozzle body 82 and the desired flame discharge pattern in the main combustion chamber 30 resulting from the combustion phase in the nozzle 50. For example, in the illustrated embodiment, the nozzle body 82 includes six orifices (four of which are shown in FIG. 1 with the other two being mirror images of the second and third orifices 102, 103, respectively). The six orifices are circumferentially arranged about the central longitudinal axis LA at substantially evenly-spaced angular positions (about sixty degrees apart from each other). In other embodiments, the nozzle body 82 can define a different number of orifices, such as eight or twelve orifices circumferentially arranged about the central longitudinal axis LA at substantially evenly-spaced angular positions (about forty-five degrees and about thirty apart from each other, respectively). In still other embodiments, the nozzle body 82 can define yet a different number of orifices. In yet other embodiments, the nozzle body can define orifices that have variable spacing between at least two pairs of adjacent orifices.

The orifices 101, 102, 103, 104 are circumferentially arranged about the central longitudinal axis LA at substantially evenly-spaced angular positions. The orifices 101, 102, 103, 104 are axially aligned along the central longitudinal axis LA. The nozzle body 82 includes an orifice bridge 108 which comprises the portion of the nozzle body 82 circumscribing each orifice 101, 102, 103, 104 and a series of relatively thin-walled, body web segments 110, 111, 112 circumferentially interposed between the orifices 101, 102, 103, 104. The distal tip 85 of the nozzle body 82 includes a distal terminal portion 115 which is disposed distally of the orifice bridge 108.

The orifices 101, 102, 103, 104 are respectively symmetrically disposed about the central longitudinal axis LA such that the orifices 101, 102, 103, 104 extend along substantially the same angle of inclination relative to the central longitudinal axis LA. In embodiments, the orifices 101, 102, 103, 104 can extend along a different angle of inclination relative to the central longitudinal axis LA. In still other embodiments, at least one of the orifices 101, 102, 103, 104 can extend along an angle of inclination relative to the central longitudinal axis LA that is different from at least one other of the orifices 101, 102, 103, 104.

Preferably, the orifices 101, 102, 103, 104 are configured such that the flow characteristics of a fuel/air mixture within the precombustion chamber in a region adjacent the electrode 69 of the spark plug is less turbulent and more laminar than that in the cylindrical portion 99 adjacent the distal tip 85 of the nozzle 50 where the orifices 101, 102, 103, 104 are located. The orifices 101, 102, 103, 104 can be configured such that flows of burning fuel respectively conveyed from the interior chamber 95 out through the orifices 101, 102, 103, 104 are controllably directed away from the nozzle body 82 in diverging relationship to each other, controllably expanding the burning gases away from the distal tip 85 of the nozzle 50 into the main combustion chamber 30 in order to facilitate the ignition and burning of the combustible mixture in the main combustion chamber 30 over a larger volume at the same time.

In the illustrated embodiment, the fuel combustion component in the form of the nozzle 50 includes a plurality of fuel surfaces which corresponds to the orifices 101, 102, 103, 104. The fuel surfaces in the form of the orifices 101, 102, 103, 104 are in communication with the main combustion chamber 30. In embodiments, the body of the fuel combustion component, in this case, the nozzle body 82, can be made from a first material having a first thermal conductivity value.

In the illustrated embodiment, the fuel combustion component in the form of the nozzle 50 also includes a plurality of thermal conductor members 121, 122, 123, 124, 125, 126. The thermal conductor members 121, 122, 123, 124, 125, 126 are disposed within the nozzle body 82. The illustrated thermal conductor members 121, 122, 123, 124, 125, 126 are embeddedly disposed within the nozzle body 82 such that the thermal conductor members 121, 122, 123, 124, 125, 126 are in conductive heat-transferring relationship with the nozzle body substantially omni-directionally.

The thermal conductor members 121, 122, 123, 124, 125, 126 can be made from a second material having a second thermal conductivity value. The second material is different from the first material used to make the nozzle body 82. The thermal conductivity value of the second material used to make the thermal conductive members 121, 122, 123, 124, 125, 126 is greater than the thermal conductivity value of the first material used to make the nozzle body 82.

In embodiments, at least one of the thermal conductor members 121, 122, 123, 124, 125, 126 can be made from a material that is different from at least one other of the thermal conductor members 121, 122, 123, 124, 125, 126. In such embodiments, each material used to make the thermal conductor members 121, 122, 123, 124, 125, 126 can have a thermal conductivity value that is higher than the conductivity value of the material used to make the body of the fuel combustion component—the nozzle body 82 in the embodiment illustrated in FIG. 1.

In embodiments, the body of the fuel combustion component (such as, the nozzle body 82 of the nozzle 50) is manufactured from a suitable material, such as a metal alloy. In embodiments, the body is made from a nickel alloy. In embodiments, the body is made from at least one of a nickel alloy and a steel.

In embodiments, each thermal conductor member 121, 122, 123, 124, 125, 126 is made from a suitable material, such as a metal having a higher thermal conductivity value than the material from which the associated body (the nozzle body 82 in the embodiment illustrated in FIG. 1) is made. In embodiments, each of the thermal conductor members 121, 122, 123, 124, 125, 126 is made from one or more of aluminum, copper, gold, silver, and an alloy thereof. In some embodiments, the thermal conductor member 121, 122, 123, 124, 125, 126 is made from oxygen-free copper.

Referring to FIG. 1, each of the thermal conductor members 121, 122, 123 extends between a first end disposed adjacent the fuel surface in the form of the first orifice 101 and a second end disposed adjacent the coolant passage 33. Each of the thermal conductor members 124, 125, 126 extends between a first end disposed adjacent the fuel surface in the form of the fourth orifice 104 and a second end disposed adjacent the coolant passage 33. The first end of each of the thermal conductor members 124, 125, 126 can be disposed nearer to the fuel surface in the form of the first orifice 101 than the second end thereof. The second end of each of the thermal conductor members 124, 125, 126 can be disposed nearer to the coolant passage 33 than the first end thereof. It should be understood that the other orifices 102, 103 of the nozzle body 82 also include a corresponding set of thermal conductor members associated therewith which are arranged in the same fashion. In embodiments, the distal terminal portion 115 of the nozzle body 82 is substantially free of thermal conductor members.

In the illustrated embodiment, the thermal conductor members 121, 122, 123, 124, 125, 126 are configured to reduce the temperature in the orifice bridge 108 of the nozzle body 82 when the fuel combustion system 20 is in operation. Each of the thermal conductor members 121, 122, 123, 124, 125, 126 is oriented over a thermal conduction path along a primary direction of heat flow to facilitate heat transfer away from the orifice bridge 108 which is subjected to high temperature when in use. Each of the thermal conductor members 121, 122, 123, 124, 125, 126 extends between the orifice bridge 108 and a region of the nozzle body 82 (in the illustrated example, the portion of the nozzle body 82 in axial alignment with the coolant passage 33) which is cooler than the orifice bridge 108 when in the intended operating environment for the fuel combustion component 50.

In the illustrated embodiment, the thermal conductor members 121, 122, 123, 124, 125, 126 comprise thermal conductor filaments. In embodiments, the thermal conductor filaments 121, 122, 123, 124, 125, 126 are substantially cylindrical, thread-like members that each has a circular transverse cross-sectional shape and an axial length greater than its corresponding diameter by more than an order of magnitude. The thermal conductor filaments 121, 122, 123, 124, 125, 126 are shown sectioned through their centers in FIG. 1. The illustrated thermal conductor filaments 121, 122, 123, 124, 125, 126 occupy a small fraction of the total volume defined by the body (nozzle body 82 in FIG. 1) of the fuel combustion component (nozzle 50 in FIG. 1). In embodiments, at least one thermal conductor filament can have a different transverse cross-sectional shape. In embodiments, at least one thermal conductor filament can have a transverse cross-sectional shape that varies along its axial length. In other embodiments, the thermal conductor members 121, 122, 123, 124, 125, 126 can have a different shape and/or size.

In embodiments, the body (nozzle body 82 in FIG. 1) of the fuel combustion component (nozzle 50 in FIG. 1) defines a body volume within which the material of the body is disposed. The thermal conductors 121, 122, 123, 124, 125, 126 disposed within the body collectively define a thermal conductor volume. In embodiments, the thermal conductor volume is no more than ten percent of the body volume, no more than five percent of the body volume in still other embodiments, and no more than three percent of the body volume in yet other embodiments. In embodiments, the percent volume of the body occupied by the thermal conduct member(s) can be adjusted to obtain the desired heat transfer characteristics from the thermal conductor member(s) while maintaining the desired strength characteristics from the material of the body.

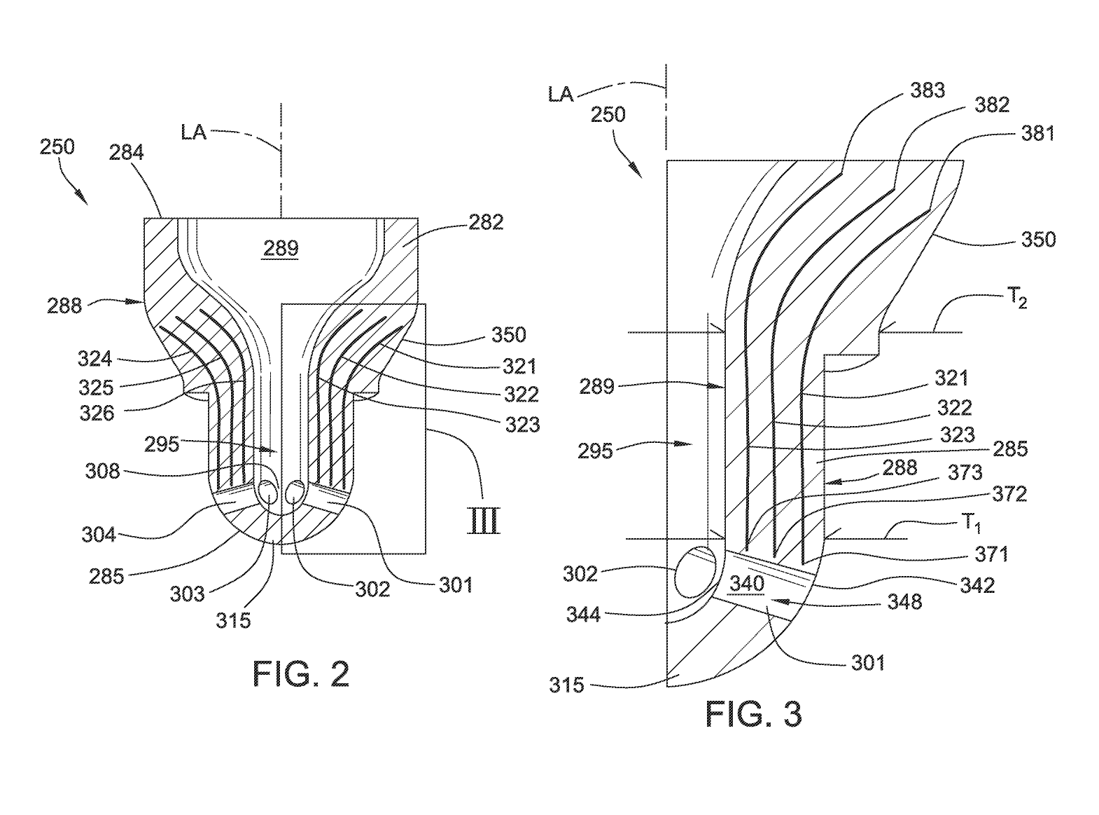

Referring to FIGS. 2 and 3, another embodiment of a fuel combustion component in the form of a nozzle 250 constructed in accordance with principles of the present disclosure is shown. The nozzle 250 is suitable for use in a fuel combustion system constructed in accordance with principles of the present disclosure, such as the fuel combustion system 20 of FIG. 1.

The nozzle 250 includes a nozzle body 282 having a mounting end 284 and a distal tip 285. The nozzle body 282 defines the central longitudinal axis LA which extends between the mounting end 284 and the distal tip 285. The nozzle body 282 is hollow and includes an outer surface 288 and an inner surface 289. The inner surface 289 defines an interior chamber 295. The outer surface 288 and the inner surface 289 are both surfaces of revolution about the central longitudinal axis LA. The nozzle body 282 is made from a first material having a first thermal conductivity value.

Referring to FIG. 2, the nozzle body 282 defines a plurality of orifices 301, 302, 303, 304 in the distal tip 285. The orifices 301, 302, 303, 304 are in communication with the interior chamber 295 defined by the nozzle body 282 and with the main combustion chamber 30 when the prechamber assembly 25 is installed in the cylinder head 24. The nozzle body 282 includes an orifice bridge 308 within which the orifices 301, 302, 303, 304 are disposed. The orifices 301, 302, 303, 304 of the nozzle body 282 are substantially the same. Accordingly, it will be understood that the description of one orifice 301 is applicable to the other orifices 302, 303, 304, as well.

Referring to FIG. 3, the nozzle body 282 includes a fuel surface 340 that defines the orifice 301. The fuel surface 340 is in the form of an orifice surface that is substantially cylindrical. The outer surface 88 defines an outer opening 342, and the inner surface 89 defines an inner opening 344. The fuel surface 340 in the form of the orifice surface defines an orifice passage 348 extending between, and in communication with, the outer opening 342 defined by the outer surface 288 of the nozzle body 282 and the inner opening 344 defined by the inner surface 289 of the nozzle body 282. The orifice passage 348 is in communication with the interior chamber 295 via the inner opening 344 and with the main combustion chamber 30 via the outer opening 342 when the nozzle 250 is installed in the fuel combustion system 20.

The fuel surface 340 is configured to be in heat-transferring relationship with a source of fuel within the fuel combustion system 20. For example, the fuel surface 340 of the orifice 301 can come into heat-transferring relationship with a flow of fuel mixture passing through the orifice 301 into the interior chamber 295 from the main combustion chamber 30. The fuel surface 340 of the orifice 301 can also come into heat-transferring relationship with a flow of a flame front passing through the orifice 301 out of the interior chamber 295.

The nozzle body 282 includes an intermediate portion 350 which is disposed between the mounting end 284 and the distal tip 285 along the central longitudinal axis LA (see FIG. 2 also). The distal tip 285 has a first thickness T₁ defined transversely between the outer surface 288 and the inner surface 289 at the distal tip 285. The intermediate portion 350 has a second thickness T₂ defined transversely between the outer surface 288 and the inner surface 289 at the intermediate portion 350. The second thickness T₂ is greater than the first thickness T₁. The thickness differences of the nozzle body 282 define a thermal conduction path that extends between the orifice surface 340 and the intermediate portion 350. In the illustrated embodiment, the intermediate portion 350 has a thickness that varies along the central longitudinal axis LA and includes the region in which the thickness of the nozzle body 282 is greater than that found in the distal tip adjacent the orifice surface 340.

In the illustrated embodiment, the fuel combustion component in the form of the nozzle 250 also includes a plurality of thermal conductor members 321, 322, 323, 324, 325, 326. The thermal conductor members 321, 322, 323, 324, 325, 326 are disposed within the nozzle body 282. In embodiments, the thermal conductor members 321, 322, 323, 324, 325, 326 are disposed within the nozzle body 282 such that each thermal conductor member 321, 322, 323, 324, 325, 326 is in direct, contacting relationship with the nozzle body 282. In embodiments, the thermal conductor members 321, 322, 323, 324, 325, 326 are embedded within the nozzle body 282 such that each thermal conductor member 321, 322, 323, 324, 325, 326 is in directing contacting relationship with the nozzle body 282 over substantially all of the external surface of each thermal conductor member 321, 322, 323, 324, 325, 326. The illustrated thermal conductor members 321, 322, 323, 324, 325, 326 are embeddedly disposed within the nozzle body 282 such that the thermal conductor members 321, 322, 323, 324, 325, 326 are in conductive heat-transferring relationship with the nozzle body 282 substantially omni-directionally.

The illustrated body of a fuel combustion component—the nozzle body 82—is made from a first material having a first thermal conductivity value. The illustrated thermal conductor members 321, 322, 323, 324, 325, 326 are each made from a second material having a second thermal conductivity value. The second material is different from the first material used to make the nozzle body 282. The thermal conductivity value of the second material used to make the thermal conductor members 321, 322, 323, 324, 325, 326 is greater than the thermal conductivity value of the first material used to make the nozzle body 282.

In embodiments, each of the orifices 301, 302, 303, 304 has at least one thermal conductor member 321, 324 associated therewith which respectively extends from the plurality of orifice surfaces 301, 302, 303, 304 along one of a plurality of thermal conduction paths defined within the nozzle body 282. In the illustrated embodiment, each of the orifices 301, 302, 303, 304 has three thermal conductor members 321, 322, 323; 324, 325, 326 associated therewith. In other embodiments, a different number of thermal conductor members can be associated with each orifice. In yet other embodiments, at least one orifice can have a number of thermal conductor members associated with it that is different from the number of thermal conductor members associated with at least one other orifice of the nozzle body.

In the illustrated embodiment, each orifice 301, 302, 303, 304 of the nozzle body 282 has the same configuration and relative relationship with its associated thermal conductor members. Accordingly, it will be understood that the description of one orifice and its associated thermal conductor members is applicable to the other orifices and their respective thermal conductors, as well.

The first, second, and third thermal conductor members 321, 322, 323 are associated with the first orifice 301 and are in radial spaced relationship to each other relative to the central longitudinal axis LA. The first thermal conductor member 321 is disposed radially outward of the second thermal conductor member 322, which, in turn, is disposed radially outward of the third thermal conductor member 323. The first, second, and third thermal conductor members 321, 322, 323 each extends along a thermal conduction path defined within the nozzle body 282 between the first orifice 301 and the intermediate portion 350. The first, second, and third thermal conductor members 321, 322, 323 are substantially axially aligned with each other along the central longitudinal axis LA.

In the illustrated embodiment, the thermal conductor members 321, 322, 323, 324, 325, 326 comprise thermal conductor filaments which are cylindrical. In other embodiments, the thermal conductor members 321, 322, 323, 324, 325, 326 can have a different configuration, such as, a ribbon shape having a rectangular transverse cross-section shape with a thickness smaller than its depth, for example.

Referring to FIG. 3, each of the thermal conductor members 321, 322, 323 extends from the fuel surface 340 in the form of the orifice surface along the central longitudinal axis LA toward the mounting end 284 (see FIG. 2 also). Each of the thermal conductor members 321, 322, 323 includes a first end 371, 372, 373 and a second end 381, 382, 383. Each of the thermal conductor members 321, 322, 323 extends between a respective first end 371, 372, 373, which is disposed adjacent the fuel surface 340 in the form of the first orifice 301, and a respective second end 381, 382, 383, which is in distal relationship to the fuel surface relative to the first end 371, 372, 373.

Each of the thermal conductor members 321, 322, 323 extends from the first end 371, 372, 373 to the second end 381, 382, 383, respectively, along a thermal conduction path. The thermal conduction path is defined within the body 282 and extends away from the fuel surface in the form of the orifice surface 340. Each thermal conductor member 321, 322, 323 can be configured to follow a temperature gradient such that it is generally aligned with a primary direction of thermal flow along its axial length between the first end 371, 372, 373 and the second end 381, 382, 383, respectively.

In the illustrated embodiment, a temperature gradient is established between the relatively thin-walled distal tip 285 and the intermediate portion 350. In the illustrated embodiment, the second end 381, 382, 383 of each of the thermal conductor members 321, 322, 323, respectively, is disposed in the intermediate portion 350. It should be understood that the other orifices 302, 303, 304 of the nozzle body 282 also include a corresponding set of thermal conductor members associated therewith which are arranged in the same fashion. For example, the third, fourth, and fifth thermal conductor members 324, 325, 326 have a relationship with the fourth orifice 304 that is substantially the same as the respective relationship between the first, second, and third thermal conductor members 321, 322, 323 and the first orifice 301. In embodiments, the distal terminal portion 315 of the nozzle body 282 is substantially free of thermal conductor members.

In the illustrated embodiment, the thermal conductor members 321, 322, 323, 324, 325, 326 are configured to reduce the temperature in the orifice bridge 308 of the nozzle body 282. Each of the thermal conductor members 321, 322, 323, 324, 325, 326 is oriented over a thermal conduction path along a primary direction of heat flow to facilitate heat transfer away from the orifice bridge 308 which is subjected to high temperature when in use. Each of the thermal conductor members 321, 322, 323, 324, 325, 326 extends between the orifice bridge 308 and a region of the nozzle body 282 (in the illustrated example, the intermediate portion 350) which is cooler than the orifice bridge 308 when in the intended operating environment for the fuel combustion component 250. The nozzle 250 of FIGS. 2 and 3 is similar in other respects to the nozzle 50 of FIG. 1.

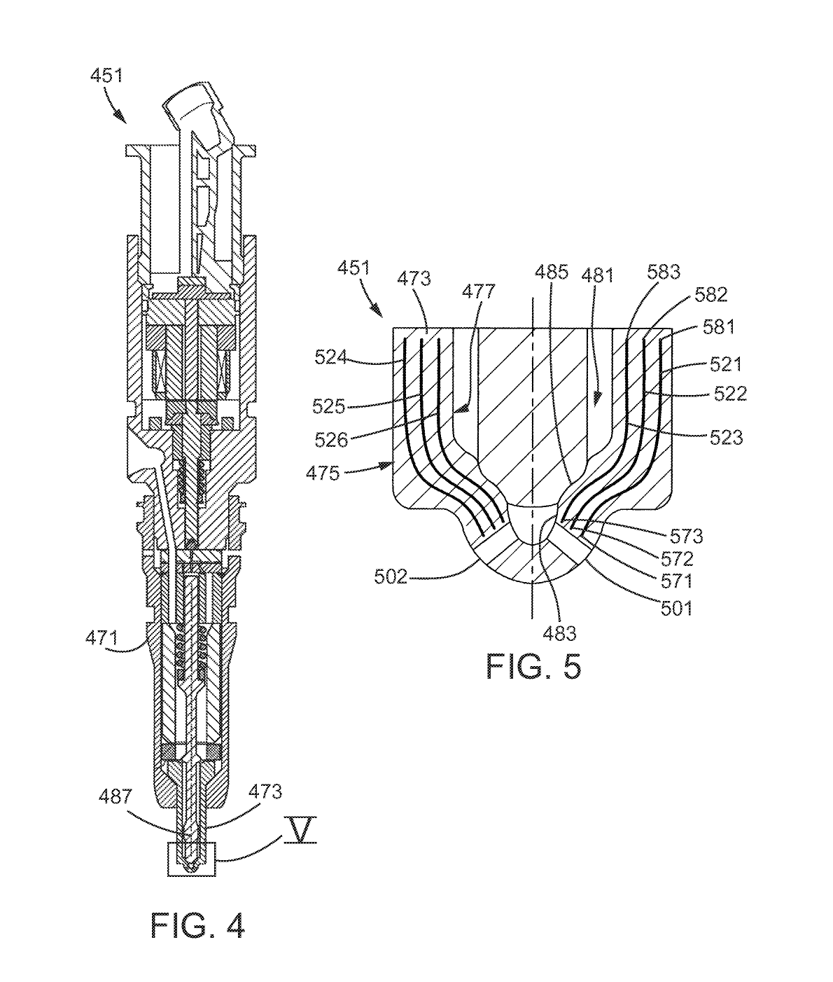

Referring to FIGS. 4 and 5, an embodiment of a fuel injector 451 constructed in accordance with principles of the present disclosure is shown. The fuel injector 451 is suitable for use in a fuel combustion system constructed in accordance with principles of the present disclosure, such as the fuel combustion system 20 of FIG. 1.

The fuel injector 451 includes a multi-piece injector housing 471 defining a central longitudinal axis LA. The multi-piece injector housing 471 is configured to retain an embodiment of a fuel combustion component in the form of a tip piece 473 constructed according to principles of the present disclosure.

Referring to FIG. 5, the tip piece 473 includes an outer surface 475 and an inner surface 477. The inner surface 477 defines a nozzle interior chamber 481 separated from a sac 483 by a needle valve seat 485. The tip piece 473 defines a plurality of orifices 501, 502 that extend between the sac 483 and the outer surface 475. A needle valve member 487 (see FIG. 4 also) is positioned in the tip piece 473 and the multi-piece injector housing 471. The needle valve member 487 is movable between a closed position in contact with the needle valve seat 485 (as shown) to block the nozzle interior chamber 481 to the orifices 501, 502, and an open position out of contact with the needle valve seat 485 to fluidly connect the nozzle interior chamber 481 to the orifices 501, 502 via the sac 483. In embodiments, the fuel injector 451 can be configured to be used with any suitable fuel mixture, such as liquid diesel fuel. In embodiments, a source of a suitable fuel mixture can be provided to the nozzle interior chamber 481 at an injection pressure.

In the illustrated embodiment, the fuel combustion component in the form of the tip piece 473 also includes a plurality of thermal conductor members 521, 522, 523, 524, 525, 526. The thermal conductor members 521, 522, 523, 524, 525, 526 are disposed within the tip piece 473. The illustrated thermal conductor members 521, 522, 523, 524, 525, 526 are embeddedly disposed within the tip piece 473 such that the thermal conductor members 521, 522, 523, 524, 525, 526 are in conductive heat-transferring relationship with the tip piece 473 substantially omni-directionally. The illustrated thermal conductor members 521, 522, 523, 524, 525, 526 comprise thermal conductor filaments which are cylindrical.

The illustrated body of a fuel combustion component—the tip piece 473—is made from a first material having a first thermal conductivity value. The thermal conductor members 521, 522, 523, 524, 525, 526 are each made from a second material having a second thermal conductivity value. The second material is different from the first material used to make the tip piece 473. The thermal conductivity value of the second material used to make the thermal conductor members 521, 522, 523, 524, 525, 526 is greater than the thermal conductivity value of the first material used to make the tip piece 473.

In the illustrated embodiment, each of the orifices 501, 502 has three thermal conductor members 521, 522, 523; 524, 525, 526 associated therewith. In other embodiments, a different number of thermal conductor members can be associated with each orifice. In yet other embodiments, at least one orifice can have a number of thermal conductor members associated with it that is different from the number of thermal conductor members associated with at least one other orifice of the tip piece 473.

In the illustrated embodiment, each orifice 501, 502 of the tip piece 473 has the same configuration and relative relationship with its associated thermal conductor members 521, 522, 523; 524, 525, 526. Accordingly, it will be understood that the description of one orifice and its associated thermal conductor members is applicable to the other orifices and their respective thermal conductors, as well.

Referring to FIG. 5, each of the thermal conductor members 521, 522, 523 includes a first end 571, 572, 573 and a second end 581, 582, 583. Each of the thermal conductor members 521, 522, 523 extends between a respective first end 571, 572, 573, which is disposed adjacent the fuel surface in the form of the first orifice 501, and a respective second end 581, 582, 583, which is in distal relationship to the fuel surface relative to the first end 571, 572, 573. Each of the thermal conductor members 521, 522, 523 extends from the first end 571, 572, 573 to the second end 581, 582, 583, respectively, along a thermal conduction path. The thermal conduction path is defined within the tip piece 473 and extends away from the fuel surface in the form of the first orifice 501. Each thermal conductor member 521, 522, 523 is configured to follow a temperature gradient such that it is generally aligned with a primary direction of thermal flow along its axial length between the first end 571, 572, 573 and the second end 581, 582, 583, respectively. In embodiments, a fuel injector having a fuel combustion component in the form of a tip piece constructed in accordance with principles of the present disclosure can include other thermal conductor member arrangements as discussed above.

It will be apparent to one skilled in the art that various aspects of the disclosed principles relating to fuel combustion systems and fuel combustion components can be used with a variety of engines. Accordingly, one skilled in the art will understand that, in other embodiments, an engine following principles of the present disclosure can include different fuel combustion components constructed according to principles of the present disclosure and can take on different forms.

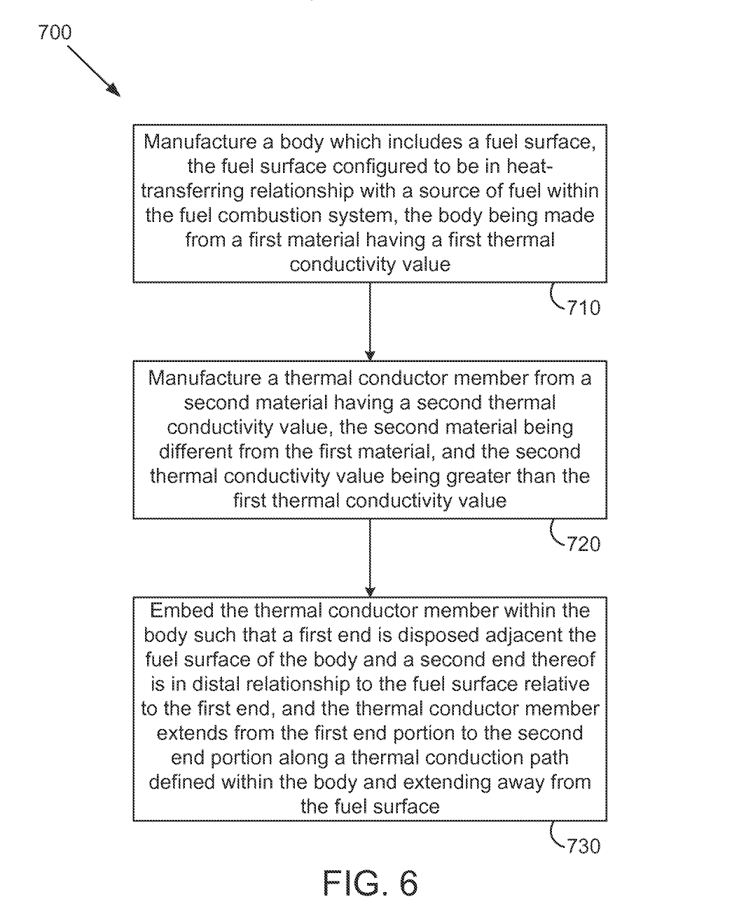

Referring to FIG. 6, steps of an embodiment of a method 700 of making a fuel combustion component of a fuel combustion system of an engine following principles of the present disclosure are shown. In embodiments, a method of making a fuel combustion component of a fuel combustion system of an engine following principles of the present disclosure can be used to make any embodiment of a fuel combustion component according to principles of the present disclosure.

The illustrated method 700 of making a fuel combustion component includes manufacturing a body (step 710). The body includes a fuel surface configured to be in heat-transferring relationship with a source of fuel within the fuel combustion system. The body is made from a first material having a first thermal conductivity value.

A thermal conductor member is manufactured (step 720). The thermal conductor member includes a first end and a second end. The thermal conductor member extends between the first end and the second end. The thermal conductor member is made from a second material having a second thermal conductivity value. The second material is different from the first material, and the second thermal conductivity value is greater than the first thermal conductivity value.

In embodiments, the body is manufactured from a suitable material, such as a metal alloy. In embodiments, the body is made from at least one of a nickel alloy and a steel. In embodiments, the body is made from a nickel alloy.

In embodiments, the thermal conductor member is made from a suitable material, such as a metal having a higher thermal conductivity value than the material from which the associated body is made. In embodiments, the thermal conductor member is made from one or more of aluminum, copper, gold, silver, and an alloy thereof. In some embodiments, the thermal conductor member is made from oxygen-free copper.

The thermal conductor member is embedded within the body (step 730) such that the first end is disposed adjacent the fuel surface of the body. The second end is in distal relationship to the fuel surface relative to the first end. The thermal conductor member extends from the first end to the second end along a thermal conduction path defined within the body and extending away from the fuel surface.

In embodiments of a method of making a fuel combustion component following principles of the present disclosure, the body comprises a nozzle body. The nozzle body is hollow and includes an outer surface, an inner surface, and the fuel surface. The outer surface defines an outer opening. The inner surface defines an interior chamber and an inner opening. The fuel surface comprises an orifice surface that defines an orifice passage extending between, and in communication with, the outer opening and the inner opening. The orifice passage is in communication with the interior chamber via the inner opening. In embodiments, the nozzle body can be any suitable nozzle body for use in a fuel combustion system. For example, the nozzle body can be suitable for use as a nozzle of a prechamber assembly in some embodiments or as a tip piece of a fuel injector in other embodiments.

In embodiments of a method of making a fuel combustion component following principles of the present disclosure, the body and each thermal conductor are manufactured via additive manufacturing (also sometimes referred to as “additive layer manufacturing” or “3D printing”). In embodiments, any suitable additive manufacturing equipment can be used. For example, in embodiments, a production 3D printer commercially available under the under the brand name ProX™ 200 from 3D Systems, Inc. of Rock Hill, S.C., can be used. In embodiments of a method of making a fuel combustion component following principles of the present disclosure, the body and each thermal conductor member are manufactured together via additive manufacturing, and each thermal conductor member is manufactured and embedded within the body substantially simultaneously.

In embodiments of a method of making a fuel combustion component following principles of the present disclosure, the method includes manufacturing a plurality of thermal conductor filaments. Each of the plurality of thermal conductor filaments has a first end and a second end. The plurality of thermal conductor filaments is embedded within the body such that the plurality of thermal conductor members is in spaced relationship to each other. The first end of each of the plurality of thermal conductor filaments is disposed adjacent the fuel surface of the body. The second end of each of the plurality of thermal conductor filaments is in distal relationship to the fuel surface relative to the first end thereof. Each of the plurality of thermal conductor filaments extends from the first end to the second end thereof along the thermal conduction path. The body and the plurality of thermal conductor filaments are manufactured via additive manufacturing. In embodiments, each of the plurality of thermal conductor filaments is manufactured and embedded within the body substantially simultaneously.

In embodiments of a method of making a fuel combustion component following principles of the present disclosure, the configuration and placement of each thermal conductor member within the body can based upon thermal data obtained from computer modeling techniques applied to the body. For example, in embodiments of a method of making a fuel combustion component following principles of the present disclosure, a model of a thermal gradient of the body is generated using a set of fuel combustion system operating characteristics. In embodiments, the set of fuel combustion system operating characteristics includes a temperature profile for the fuel combustion system and flow characteristics of a flow of a fuel mixture/flame front in communication with the fuel surface of the body. A thermal conduction path of the body is identified using the model. The thermal conductor member is configured to substantially align with and follow the identified thermal conduction path. In embodiments, any suitable modeling technique known to those skilled in the art can be used. For example, in embodiments, the model of the thermal gradient is generated using at least one of thermal imaging, material analysis, finite element analysis, and computational fluid dynamics analysis.

### INDUSTRIAL APPLICABILITY

The industrial applicability of the embodiments of fuel combustion systems, nozzles for a member of a fuel combustion system of an engine, and methods of making nozzles for a member of a fuel combustion system of an engine as described herein will be readily appreciated from the foregoing discussion. In embodiments, a nozzle constructed according to principles of the present disclosure can be used in a suitable member of a fuel combustion system of an engine, such as, a fuel injector or a prechamber assembly, for example. Embodiments of a fuel combustion component and/or a fuel combustion system according to principles of the present disclosure may find potential application in any suitable engine. Exemplary engines include those used in electrical generators and pumps, for example.

Embodiments of a fuel combustion component constructed according to principles of the present disclosure can be made using additive manufacturing techniques. The thermal conductor members can be made using additive manufacturing techniques from a material having a higher thermal conductivity value than the material used to make the body within which the thermal conductor members are embedded. The thermal conductor members can be oriented over a thermal conduction path along a primary direction of heat flow between a region of the fuel combustion component subjected to relatively high temperature, such as an orifice bridge of a nozzle, for example, and a region of the fuel combustion component which is cooler when in the intended operating environment for the fuel combustion component to facilitate heat transfer.

The thermal conductor members can serve as thermal drain channels which occupy a small percent volume of the body volume defined by the material of the body of the component. The higher thermal conductivity value of the thermal conductor members can increase the useful life of the fuel combustion component and help it withstand the ablative nature of the flows of fuel mixture/flame front with which its fuel surface comes into heat-transferring relationship. The improved heat transfer characteristics can help reduce the amount of heat-induced damage suffered by the fuel combustion component during operation.

For example, in internal combustion engines, above a particular capacity, the energy of an ignition spark may no longer be sufficient to ignite reliably the combustion gas/air mixture, which for emissions reasons is often very lean, in the main combustion chamber. To increase the ignition energy, a prechamber assembly constructed according to principles of the present disclosure can be connected to the cylinder head and placed in communication with the main combustion chamber via a plurality of orifices defined in the nozzle. A small part of the mixture is enriched with a small quantity of combustion gas or an additional fuel and ignited in the precombustion chamber.

Flame propagation, i.e. ignition kernel, is transferred to the main combustion chamber by way of the orifices in the nozzle and the flame propagation ignites the lean fuel mixture. The discharge flame pattern emitting from the nozzle is advantageous because it has a hot surface area that can ignite even extremely lean or diluted combustible mixtures in a repeatable manner. In embodiments where the fuel combustion component comprises a nozzle body and the fuel surface comprises an orifice passage, a thermal conductor member can be associated with each orifice passage. The thermal conductor members can help reduce the temperature in the orifices and the orifice bridges disposed between the orifices arrayed around the nozzle body.

In embodiments, the ignited mixture within the prechamber is discharged through the orifices of the nozzle into the main combustion chamber with increased heat transfer effects through the body as a result of the thermal conductor members embedded within the nozzle body. The flame area produced by a prechamber assembly constructed according to principles of the present disclosure can help improve combustion of a lean fuel mixture in the main combustion chamber of the cylinder with which it is associated.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A fuel combustion component of a fuel combustion system of an engine, the fuel combustion component comprising:
a body, the body including a fuel surface, the fuel surface configured to be in heat-transferring relationship with a source of fuel within the fuel combustion system, the body being made from a first material having a first thermal conductivity value;
a thermal conductor member, the thermal conductor member being disposed within the body, the thermal conductor member being made from a second material having a second thermal conductivity value, the second material being different from the first material, and the second thermal conductivity value being greater than the first thermal conductivity value;
wherein the thermal conductor member includes a first end and a second end, the first end disposed adjacent the fuel surface of the body, the second end in distal relationship to the fuel surface relative to the first end, and the thermal conductor member extending between the first end and the second end along a thermal conduction path, the thermal conduction path being defined within the body and extending away from the fuel surface.

2. The fuel combustion component according to claim 1, wherein the thermal conductor member comprises a thermal conductor filament.

3. The fuel combustion component according to claim 1, wherein the first material comprises at least one of a nickel alloy and a steel.

4. The fuel combustion component according to claim 1, wherein the second material comprises at least one of aluminum, copper, gold, silver, and an alloy thereof.

5. The fuel combustion component according to claim 4, wherein the first material comprises at least one of a nickel alloy and a steel.

6. The fuel combustion component according to claim 1, wherein the body comprises a nozzle body, the nozzle body being hollow and including an outer surface, an inner surface, and the fuel surface, the outer surface defining an outer opening, the inner surface defining an interior chamber and an inner opening, the fuel surface comprising an orifice surface, and the orifice surface defining an orifice passage extending between, and in communication with, the outer opening and the inner opening, the orifice passage being in communication with the interior chamber via the inner opening.

7. The fuel combustion component according to claim 6, wherein the nozzle body includes a plurality of orifice surfaces defining a plurality of orifices, and wherein the thermal conductor member is one of a plurality of thermal conductor members, the plurality of thermal conductor members corresponding to the plurality of orifices, the plurality of thermal conductor members respectively extending from the plurality of orifice surfaces along one of a plurality of thermal conduction paths defined within the body.

8. The fuel combustion component according to claim 6, wherein the nozzle body includes a mounting end and a distal tip, the nozzle body defining a central longitudinal axis extending between the mounting end and the distal tip, and the distal tip including the orifice surface, and wherein the thermal conductor member extends from the orifice surface along the central longitudinal axis toward the mounting end.

9. The fuel combustion component according to claim 8, wherein the nozzle body includes an intermediate portion, the intermediate portion disposed between the mounting end and the distal tip along the central longitudinal axis, the distal tip having a first thickness defined between the outer surface and the inner surface at the distal tip, the intermediate portion having a second thickness defined between the outer surface and the inner surface at the intermediate portion, the second thickness being greater than the first thickness, and wherein the thermal conduction path extends between the orifice surface and the intermediate portion, and the second end of the thermal conductor member is disposed in the intermediate portion.

10. The fuel combustion component according to claim 6, wherein the outer surface and the inner surface each comprises a surface of revolution about a central longitudinal axis, and the thermal conductor member comprises one of a plurality of thermal conductor members, the plurality of thermal conductor members being in radial spaced relationship to each other relative to the central longitudinal axis, and the plurality of thermal conductor members each extending along the thermal conduction path.

11. The fuel combustion component according to claim 10, wherein the plurality of thermal conductor members is substantially axially aligned with each other along the central longitudinal axis.

12. A fuel combustion system comprising:
a cylinder block, the cylinder block defining, at least partially, a main combustion chamber;
a cylinder head, the cylinder head removably attached to the cylinder block, at least one of the cylinder block and the cylinder head defining a coolant passage, the coolant passage adapted to be placed in communication with a source of coolant;
a fuel combustion component, the fuel combustion component in communication with the main combustion chamber, the fuel combustion component including:
a body, the body being positioned adjacent the coolant passage, the body including a fuel surface, the fuel surface in communication with the main combustion chamber, the body being made from a first material having a first thermal conductivity value,
a thermal conductor member, the thermal conductor member being disposed within the body, the thermal conductor member being made from a second material having a second thermal conductivity value, the second material being different from the first material, and the second thermal conductivity value being greater than the first thermal conductivity value, and
wherein the thermal conductor member includes a first end and a second end, the thermal conductor member extending between the first end and the second end, the first end being disposed adjacent the fuel surface of the body, and the second end being disposed adjacent the coolant passage.

13. The fuel combustion system according to claim 12, wherein the body of the fuel combustion component comprises a nozzle body, the nozzle body being hollow and including an outer surface, an inner surface, and the fuel surface, the outer surface defining an outer opening, the inner surface defining an interior chamber and an inner opening, the fuel surface comprising an orifice surface, and the orifice surface defining an orifice passage extending between, and in communication with, the outer opening and the inner opening, the orifice passage being in communication with the interior chamber via the inner opening and with the main combustion chamber via the outer opening.

14. The fuel combustion system according to claim 13, wherein the nozzle body of the fuel combustion component includes a mounting end and a distal tip, the nozzle body defining a central longitudinal axis extending between the mounting end and the distal tip, the distal tip being in communication with the main combustion chamber and including the orifice surface, and wherein the thermal conductor member extends from the orifice surface along the central longitudinal axis toward the mounting end.

15. A method of making a fuel combustion component of a fuel combustion system of an engine, the method of making comprising:
manufacturing a body, the body including a fuel surface, the fuel surface configured to be in heat-transferring relationship with a source of fuel within the fuel combustion system, the body being made from a first material having a first thermal conductivity value;
manufacturing a thermal conductor member, the thermal conductor member including a first end and a second end, the thermal conductor member extending between the first end and the second end, the thermal conductor member being made from a second material having a second thermal conductivity value, the second material being different from the first material, and the second thermal conductivity value being greater than the first thermal conductivity value;
embedding the thermal conductor member within the body;
wherein the thermal conductor member is embedded within the body such that the first end is disposed adjacent the fuel surface of the body, the second end is in distal relationship to the fuel surface relative to the first end, and the thermal conductor member extends from the first end to the second end along a thermal conduction path, the thermal conduction path being defined within the body and extending away from the fuel surface.

16. The method of making according to claim 15, wherein the body comprises a nozzle body, the nozzle body being hollow and including an outer surface, an inner surface, and the fuel surface, the outer surface defining an outer opening, the inner surface defining an interior chamber and an inner opening, the fuel surface comprising an orifice surface, and the orifice surface defining an orifice passage extending between, and in communication with, the outer opening and the inner opening, the orifice passage being in communication with the interior chamber via the inner opening.

17. The method of making according to claim 15, wherein the thermal conductor member comprises a thermal conductor filament, the method further comprising:
manufacturing a plurality of thermal conductor filaments, each of the plurality of thermal conductor filaments having a first filament end and a second filament end;
embedding the plurality of thermal conductor filaments within the body such that the plurality of thermal conductor filaments is in spaced relationship to each other and such that the first filament end of each of the plurality of thermal conductor filaments is disposed adjacent the fuel surface of the body, the second filament end of each of the plurality of thermal conductor filaments is in distal relationship to the fuel surface relative to the first filament end thereof, and each of the plurality of thermal conductor filaments extends from the first filament end to the second filament end thereof along the thermal conduction path;
wherein the body and the plurality of thermal conductor filaments are manufactured via additive manufacturing and each of the plurality of thermal conductor filaments is manufactured and embedded within the body substantially simultaneously.

18. The method of making according to claim 15, wherein the body and the thermal conductor member are manufactured together via additive manufacturing, and the thermal conductor member is manufactured and embedded within the body substantially simultaneously.

19. The method of making according to claim 18, further comprising:
generating a model of a thermal gradient of the body using a set of fuel combustion system operating characteristics;
identifying the thermal conduction path of the body using the model;
configuring the thermal conductor member to substantially align with the thermal conduction path.

20. The method of making according to claim 19, wherein the model of the thermal gradient is generated using at least one of thermal imaging, material analysis, finite element analysis, and computational fluid dynamics analysis.
